(19) United States
(12) Patent Application Publication
(10) Pub. No.: US 2013/0109080 A1
(43) Pub. Date: May 2, 2013

(54) INTEGRATED SYSTEMS AND ASSEMBLIES FOR SAMPLE PROCESSING

(71) Applicants: Joel R. Dufresne, St. Paul, MN (US); David J. Franta, Woodbury, MN (US); Theresa J. Gerten, Inver Grove Heights, MN (US); Christopher R. Kokaisel, Woodbury, MN (US); Kurt J. Halverson, Lake Elmo, MN (US); William Bedingham, Woodbury, MN (US); James E. Aysta, Stillwater, MN (US); Barry W. Robole, Woodville, WI (US); Kenneth B. Wood, Minneapolis, MN (US)

(72) Inventors: Joel R. Dufresne, St. Paul, MN (US); David J. Franta, Woodbury, MN (US); Theresa J. Gerten, Inver Grove Heights, MN (US); Christopher R. Kokaisel, Woodbury, MN (US); Kurt J. Halverson, Lake Elmo, MN (US); William Bedingham, Woodbury, MN (US); James E. Aysta, Stillwater, MN (US); Barry W. Robole, Woodville, WI (US); Kenneth B. Wood, Minneapolis, MN (US)

(73) Assignee: 3M INNOVATIVE PROPERTIES COMPANY, ST. PAUL, MN (US)

(21) Appl. No.: 13/699,763

(22) PCT Filed: May 23, 2011
(86) PCT No.: PCT/US11/37540

§ 371 Date: Jan. 8, 2013

Related U.S. Application Data
(60) Provisional application No. 61/348,813, filed on May 27, 2010.
(60) Provisional application No. 61/409,709, filed on Nov. 3, 2010.

(51) Int. Cl. B01L 3/00

(52) U.S. Cl. CPC B01L 3/50273
USPC 435/283.1; 422/506; 422/563

(57) ABSTRACT

Methods and devices for the thermal processing of samples are disclosed, including portable, integrated processing assemblies for occluding channels in a fluidic device.

### BACKGROUND

Fluidic devices may be used for performing biological or chemical reactions and assays with small volumes of reagent and sample. Exemplary microfluidic devices are described in U.S. Pat. Nos. 6,627,159 B1 (Bedingham et al.); 6,814,935 (Harms et al.); and 7,026,168 (Bedingham et al). These and other microfluidic devices may be used in methods that involve thermal processing, e.g., sensitive chemical processes such as polymerase chain reaction (PCR) amplification, ligase chain reaction (LCR), self-sustaining sequence replication, enzyme kinetic studies, homogeneous ligand binding assays, and more complex biochemical or other processes that require precise thermal control and/or rapid thermal variations.

The microfluidic devices described in those documents may include laminated structures of a first layer with features of a process array such as process chambers and conduits embossed therein, and a second layer, which is typically flat, and forms the backside of the device. The microfluidic devices may be provided with or without carriers as described in the above-identified documents. Typically, the conduits are used to deliver liquid samples to the process chambers, often by centrifugation. Reactions are typically carried out in the process chambers after occlusion of a nearby conduit to prevent signal and chamber contamination. Most often, the progress of the reaction is monitored in these same process chambers via optical techniques such as fluorescence, absorbance, etc.

As can be appreciated, use of the microfluidic devices in the sensitive chemical processes above can involve the cooperation of multiple instrument platforms. Once a sample is introduced into the process array, the microfluidic device is typically placed in a centrifuge adapter, transferred to a centrifuge, and rotated to drive the sample into the process chambers. After the sample has reached the process chambers, the microfluidic device is removed from the centrifuge and is placed in a separate, specialized sealing apparatus to occlude the conduits. Once the conduits are occluded, the microfluidic device may then be transferred to a thermal processing and optical unit, e.g., a thermal block and optical reader, so that the reactions in the process chambers can be initiated and monitored.

### SUMMARY

The present disclosure provides an integrated processing assembly for carrying out all or substantially all of a sample processing method in a single apparatus. The integrated processing assembly enables a fluidic device to be centrifuged and occluded in the same apparatus without adaptation or additional specialized equipment. In certain implementations, the fluidic device may undergo both thermal processing and optical interrogation without needing to be removed from the integrated assembly. This increased onboard functionality may permit the design of highly distributed instrument systems which are more efficient/responsive in handling samples received at random from patients within critical medical environments.

The present disclosure provides an assembly that can be used in methods that involve thermal processing, e.g., sensitive chemical processes such as PCR amplification, ligase chain reaction (LCR), self-sustaining sequence replication, enzyme kinetic studies, homogeneous ligand binding assays, and more complex biochemical, isothermal amplification, or other processes that require precise thermal control and/or rapid thermal variations. The assembly may include, e.g., a heating element, thermal indicators, and other materials or components that facilitate rapid and accurate thermal processing of microfluidic devices.

The present disclosure provides assemblies for processing fluidic devices. In certain embodiments, the processing assemblies include a base adapted to retain a fluidic device comprising a deformable seal; a slide housing operatively connected to the base and including a staking slide, wherein the base and the slide housing define an elongated body having an open state and a closed state; and one or more sealing structures attached to the staking slide, the sealing structures facing the base, wherein each sealing structure of the one or more sealing structures is adapted to deform at least a portion of the deformable seal. In certain embodiments, the slide housing is hingedly connected to the base. The staking slide may also be enclosed within the slide housing and may travel on a rail or guide on a surface of the slide housing.

In certain embodiments, an integrated processing assembly includes a base having a cavity to retain a fluidic device including a deformable seal; a slide housing operatively connected to the base and including a contact surface; a staking slide movably mounted proximate the contact surface to traverse at least a portion of the slide housing; and one or more sealing structures coupled to the staking slide, wherein each sealing structure of the one or more sealing structures is adapted to deform at least a portion of the deformable seal.

The present disclosure additionally provides systems for processing samples. In certain embodiments, the system includes: a fluidic device including a first and second major surface and at least one deformable seal; a frame adapted to retain the fluidic device, wherein the frame includes a rail extending across at least a portion of a surface of the frame; a staking slide mounted to traverse along the rail; and sealing structures operatively connected to the staking slide, wherein the sealing structures are adapted to deform at least a portion of the at least one deformable seal and remain in contact with the second major surface as the staking slide traverses the rail.

In certain embodiments, the system includes a fluidic device comprising a body that includes a first side attached to a second side, and one or more process arrays formed between the first and second sides, and at least one deformable seal. The system may further include a processing assembly for closing the at least one deformable seal in the fluidic device, the processing assembly including; a housing having an open state and a closed state and including; a base adapted to retain a fluidic device; a slide housing operatively connected to the base at a first end and comprising a staking slide. The processing assembly may further include one or more sealing structures attached to the staking slide, the sealing structures facing the base, wherein each sealing structure of the one or more sealing structures is configured to deform at least a portion of a deformable seal of a retained fluidic device.

The present disclosure further provides methods for closing deformable seals in a fluidic device. In certain embodiments, the methods include providing a fluidic device including a body that comprises a first side attached to a second side, and one or more process arrays formed between the first and second sides, wherein each process array of the one or more process arrays comprises a loading structure, a main conduit including a length, a plurality of process chambers distributed along the main conduit, wherein the loading structure is in fluid communication with the plurality of process chambers through the main conduit, and a deformable seal located along a portion of the process array. The methods may further include locating the fluidic device in a processing assembly, the processing assembly including a base adapted to retain the fluidic device; a slide housing operatively attached to the base, a staking slide mounted for movement across the slide housing; and one or more sealing structures attached to the staking slide, the one or more sealing structures facing the fluidic device in the base; and closing at least a portion of the deformable seals in the fluidic device located on the base by traversing the slide housing with the staking slide while the fluidic device is located between the base and the bridge, wherein the one or more sealing structures deform at least a portion of the second side of the body to close the deformable seals.

As used in connection with the present invention, the following terms shall have the meanings set forth below.

“Deformable seal” (and variations thereof) means a seal that is deformable under mechanical pressure (with or without a tool) to permanently occlude a conduit along which the deformable seal is located.

“Thermal processing” (and variations thereof) means controlling (e.g., maintaining, raising, or lowering) the temperature of sample materials to obtain desired reactions. As one form of thermal processing, “thermal cycling” (and variations thereof) means sequentially changing the temperature of sample materials between two or more temperature setpoints to obtain desired reactions. Thermal cycling may involve, e.g., cycling between lower and upper temperatures, cycling between lower, upper, and at least one intermediate temperature, etc.

The terms “comprises” and variations thereof do not have a limiting meaning where these terms appear in the description and claims.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, “a,” “an,” “the,” “at least one,” and “one or more” are used interchangeably. Thus, for example, a process array that comprises “a” feeder conduit can be interpreted to mean that the processing device includes “one or more” feeder conduits.

Also herein, the recitations of numerical ranges by endpoints include all numbers subsumed within that range (e.g., 1 to 5 includes 1, 1.5, 2, 2.75, 3, 3.80, 4, 5, etc.).

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

The invention will be further described with reference to the drawings, wherein corresponding reference characters indicate corresponding parts throughout the several views, and wherein:

FIG. 1 is a perspective view of a fluidic device.

FIG. 2 is an enlarged view of a portion of one process array on the fluidic device of FIG. 1.

FIG. 3 is a cross-sectional view of a portion of the fluidic device of FIG. 1.

FIG. 4 is a cross-sectional view of the portion of the fluidic device of FIG. 3.

FIG. 5 is a cross-sectional view of the main conduit of the fluidic device of FIG. 3, taken after deformation of the main conduit to isolate the process chambers.

FIG. 6 is an exploded perspective view of an assembly including a fluidic device and a carrier according to one embodiment of the disclosure.

FIG. 7a is a perspective view of a processing assembly according to another embodiment of the present invention prior to receiving a fluidic device.

FIG. 7b is another perspective view of the processing assembly of FIG. 7a.

FIG. 8 is another perspective view of the processing assembly of FIGS. 7a and 7b.

### DETAILED DESCRIPTION OF ILLUSTRATIVE EMBODIMENTS

In the following descriptions of exemplary embodiments of the invention, reference may be made to the accompanying Figures which form a part hereof, and in which are shown, by way of illustration, specific exemplary embodiments in which the invention may be practiced. It is to be understood that other embodiments may be utilized and structural changes may be made without departing from the scope of the present invention.

In some embodiments, the present invention relates to a processing assembly that can be used in the processing of liquid sample materials (or sample materials entrained in a liquid) in multiple process chambers to obtain desired reactions, e.g., PCR amplification, ligase chain reaction (LCR), self-sustaining sequence replication, enzyme kinetic studies, homogeneous ligand binding assays, and other chemical, biochemical, or other reactions that may require precise and/or rapid thermal variations. More particularly, the present invention relates to the processing of fluidic devices that include one or more process arrays, each of which include a loading chamber, a plurality of process chambers, a main conduit placing the process chambers in fluid communication with the loading chamber, and a deformable seal for occluding at least a portion of the main conduit.

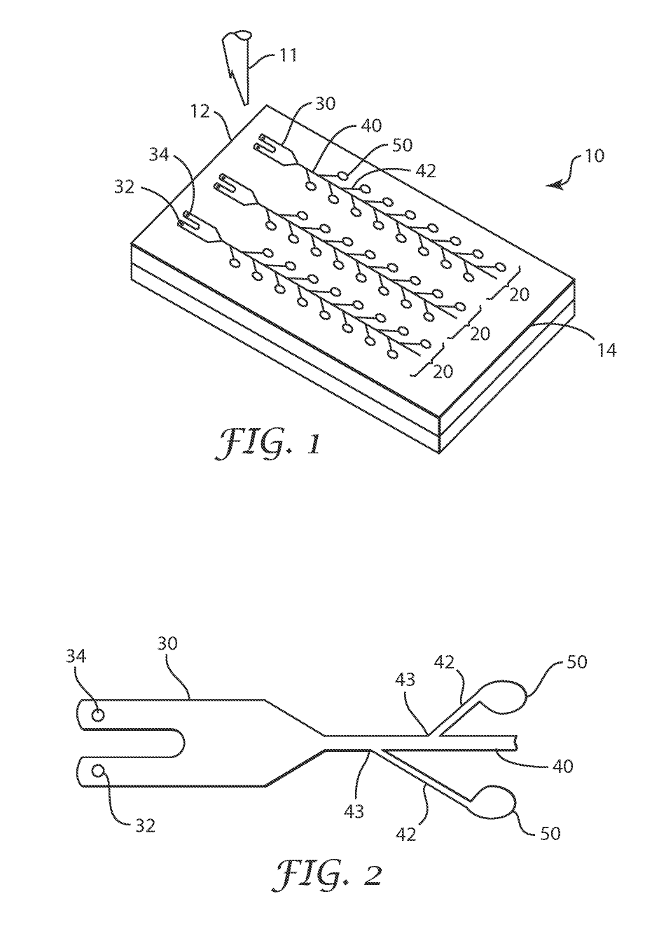

One embodiment of a fluidic device suitable for use in the processing assemblies of the present invention is illustrated in FIG. 1. The fluidic device 10 includes at least one, and preferably a plurality, of process arrays 20. Each of the depicted process arrays 20 extends from proximate a first end 12 towards the second end 14 of the fluidic device 10.

The process arrays 20 are depicted as being substantially parallel in their arrangement on the fluidic device 10. Although this arrangement may be suitable, it will be understood that any arrangement of process arrays 20 that results in their substantial alignment between the first and second ends 12 and 14 of the device 10 may alternatively be utilized.

The process arrays 20 may be aligned if the main conduits 40 of the process arrays are to be closed simultaneously as discussed in more detail below. The process arrays 20 may also be aligned if sample materials are to be distributed throughout the fluidic device by rotation about an axis of rotation proximate the first end 12 of the device 10. When so rotated, any sample material located proximate the first end 12 is driven toward the second end 14 by centrifugal forces developed during the rotation.

Each of the process arrays 20 includes at least one main conduit 40, and a plurality of process chambers 50 located along each main conduit 40. The process arrays 20 also include a loading structure 30 in fluid communication with a main conduit 40 to facilitate delivery of sample material to the process chambers 50 through the main conduit 40. As depicted in FIG. 1, each of the process arrays include only one loading structure 30 and only one main conduit 40, though other multi-loading structure/conduit implementations are also contemplated.

The process chambers 50 are in fluid communication with the main conduit 40 through feeder conduits 42. As a result, the loading structure 30 in each of the process arrays 20 is in fluid communication with each of the process chambers 50 located along the main conduit 40 leading to the loading structure 30.

If the loading structure 30 is provided in the form of a loading chamber, the loading structure 30 may include an inlet port 32 for receiving sample material into the loading structure 30. The sample material may be delivered to inlet port 32 by any suitable technique and/or equipment, such as, but not limited to, a pipette.

Each of the loading structures 30 depicted in FIG. 1 also includes a vent port 34 with the loading structure 30. The inlet port 32 and the vent port 34 may preferably be located at the opposite ends of the legs of a U-shaped loading chamber as depicted in FIGS. 1 and 2. Locating the inlet port 32 and the vent port 34 at opposite ends of the legs of a U-shaped loading chamber may assist in filling of the loading structure 30 by allowing air to escape during filling of the loading structure 30.

Methods of distributing sample materials by rotating a fluidic device about an axis of rotation located proximate the loading structures are described in U.S. Pat. No. 6,627,159 (Bedingham et al.). One suitable method includes distribution by centrifugation. It may be desirable that, regardless of the exact method used to deliver sample materials to the process chambers through the main conduits of fluidic devices of the present invention, substantially all of the process chambers, main conduit, and feeder conduits are filled with the sample material.

The process arrays 20 depicted in FIG. 1 are arranged with the process chambers 50 located on both sides of each of the main conduits 40. The process chambers 50 are in fluid communication with the main conduit 40 through feeder conduits 42. The process chambers 50 are generally circular in shape and the feeder conduits 42 entering the process chambers 50 along a tangent. Such an orientation may facilitate filling of the process chambers 50, but other shapes and orientations are contemplated and will be known to one having skill in the art.

The feeder conduits 42 are preferably angled off of the main conduit 40 to form a feeder conduit angle that is the included angle formed between the feeder conduit 42 and the main conduit 40. The feeder conduit angle may be less than 90 degrees, or 45 degrees or less. The feeder conduit angles formed by the feeder conduits 42 may be uniform or they may vary between the different process chambers 50. In another alternative, the feeder conduit angles may vary between the different sides of each of the main conduits 40. For example, the feeder conduit angles on one side of each of the main conduits 40 may be one value while the feeder conduit angles on the other side of the main conduits may be a different value.

Additional fluidic device configurations may be found, for example, in U.S. Pat. Nos. 6,627,159 and 7,026,168 (Bedingham et al.) and International Application No. 61/348,813 filed May 27, 2011 entitled METHODS AND ARTICLES FOR SAMPLE PROCESSING.

Another feature of the fluidic devices for use in the inventive processing assembly is a deformable seal that may be used to close the main conduit, isolate the process chambers 50, or accomplish both closure of the main conduit and isolation of the process chambers. As used in connection with the present invention, the deformable seals may be provided in a variety of locations and/or structures incorporated into the fluidic devices.

With respect to FIG. 1, for example, the deformable seal may be located in the main conduit 40 between the loading structure 30 and the plurality of process chambers 50 of each process array 20. In this configuration the deformable seal may extend for substantially the entire length of the main conduit 40, the entire length of the main conduit 40, or it may be limited to selected areas.

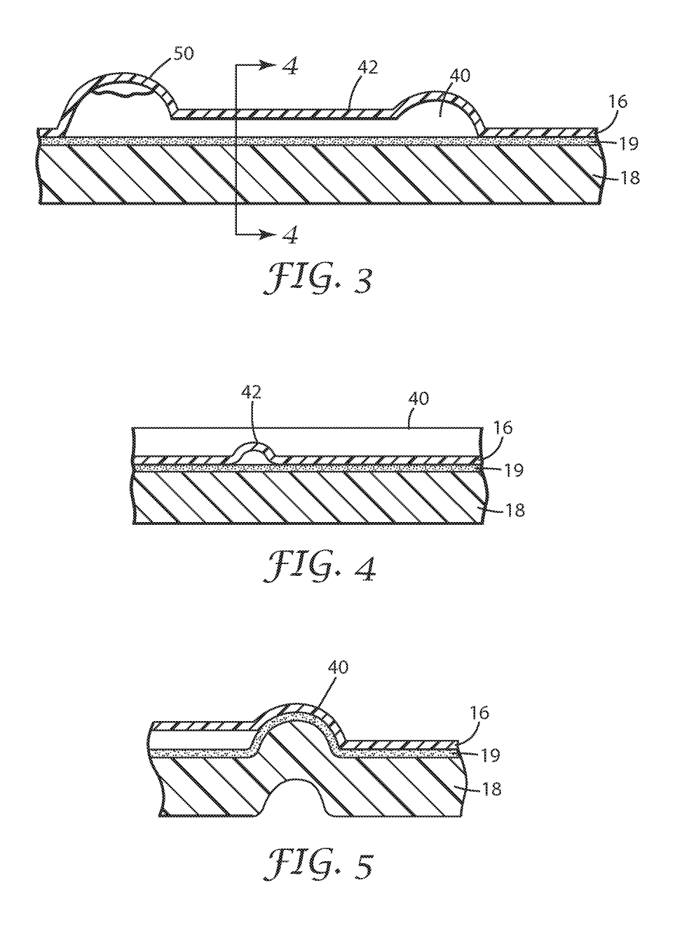

Referring to FIG. 3, closure of the deformable seals may involve plastic deformation of portions of one or both sides 16 and 18 to occlude the main conduits 40 and/or feeder conduits 42. If, for example, a pressure sensitive adhesive 19 is used to attach the first and second sides 16 and 18 of the fluidic device together, that same pressure sensitive adhesive may help to maintain occlusion of the main conduits 40 and/or feeder conduits 42 by adhering the deformed first and second sides 16 and 18 together as shown in FIG. 5. In addition, any conformability in the adhesive 19 may allow it to conform and/or deform to more completely fill and occlude the main conduits 40 and/or feeder conduits 42.

It may only be required that the deformation restrict flow, migration or diffusion through a conduit or other fluid pathway sufficiently to provide the desired isolation.

Furthermore, occlusion of the main conduit 40 may be continuous over substantially all of the length of the main conduit or it may be accomplished over discrete portions or locations along the length of the main conduit. Also, closure of the deformable seal may be accomplished by occlusion of the feeder conduits alone and/or by occlusion of the feeder conduit/main conduit junctions (in place of, or in addition to, occlusion of a portion or all of the length of the main conduit).

Referring again to FIGS. 3-5, one embodiment of a deformable seal for isolating the process chambers 50 is depicted. The deformable seal is provided in the form of a deformable second side 18 that can be deformed such that it extends into the main conduit 40 as depicted in FIG. 5.

In one method in which the process arrays 20 are closed after distribution of sample materials into process chambers 50, it may be necessary to close the deformable seal along only a portion of the main conduit 40 or, alternatively, the entire length of the main conduit 40. Where only a portion of the main conduit 40 is deformed, it may be preferred to deform that portion of the main conduit 40 located between the loading chamber 30 and the process chambers 50.

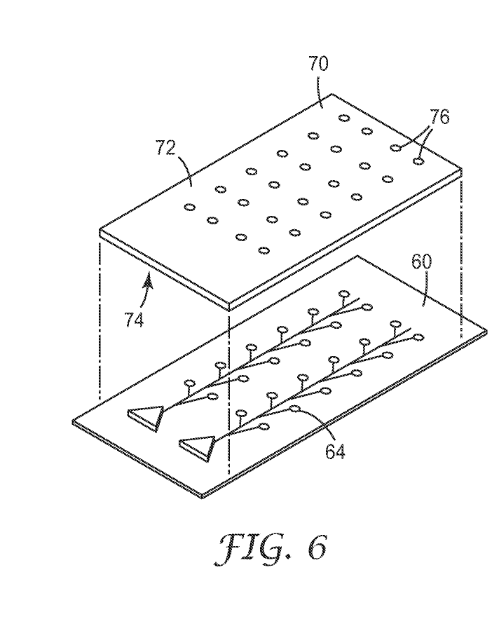

Fluidic devices may be processed alone, e.g., as depicted in FIG. 1. The fluidic device may alternatively be mounted on a carrier. Such an assembly is depicted in an exploded perspective view of fluidic device 60 and carrier 70 in FIG. 6.

The carrier 120 preferably includes two major surfaces 72 and 74. Major surface 72 faces away from the fluidic device 60 and surface 74 faces towards the fluidic device 60. The carrier 70 also preferably includes apertures 76 formed therethrough that may be aligned with process chambers 64 in the sample processing 60. The apertures 76 may allow for the transmission of light (ultraviolet, visible, infrared, and combinations thereof) into and/or out of the process chambers 64. The carrier 70 may also include structures designed to transfer compressive forces to the fluidic device 60 as discussed in a number of the documents identified herein. Additional components and constructions of the carrier may also be found in the aforementioned documents, particularly U.S. Pat. No. 7,026,168 (Bedingham et al.).

Exemplary fluidic devices may also be processed as part of a modular system. In certain embodiments, fluidic devices (with or without carriers) may be retained within corresponding openings in a frame. Suitable frames include those described in U.S. Pat. No. 7,323,660 (Bedingham et al.), but other constructions and configurations (e.g., linear frames) are contemplated. In other embodiments, the fluidic device includes interlocking features such that a fluidic device may be directly connected to another fluidic device, thereby allowing a user to select the desired number of process arrays.

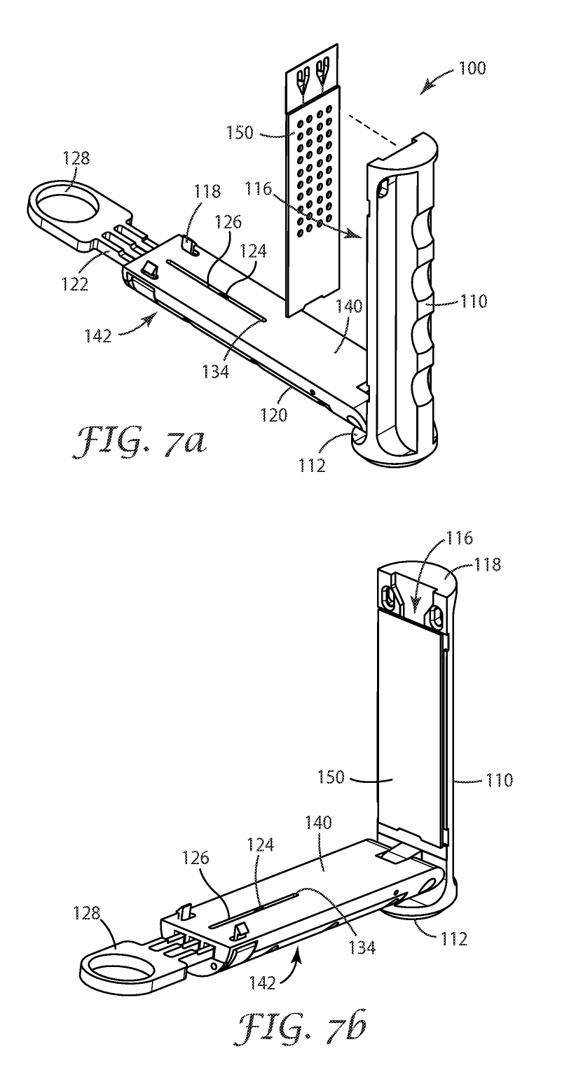

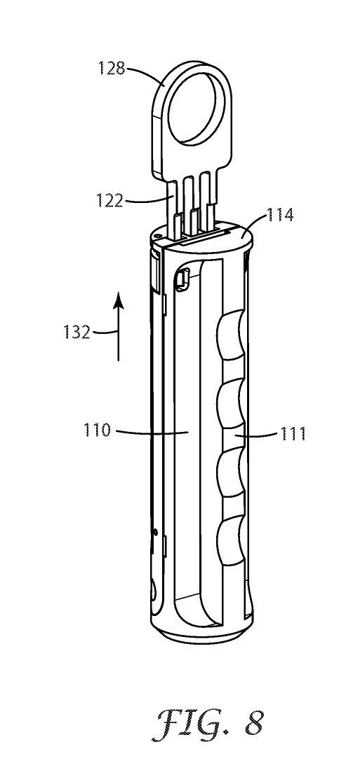

FIGS. 7a, 7b, 8 and 9 depict an integrated processing assembly for use in closing deformable seals and further processing fluidic devices. The processing assembly 100 includes a base 110 and a slide housing 120 operatively coupled to the base 110 proximate the first end 112. In one aspect as depicted in FIGS. 7a and 7b, the slide housing 120 is hingedly connected to the base 110, allowing the processing assembly to be opened and closed quickly for simplified access to the fluidic device 150. The processing assembly 100 is depicted in an open position in FIGS. 7a and 7b. Optionally, the processing assembly 100 may include a locking mechanism 118 proximate the second end 114 to secure slide housing 120 relative to base 110 during sample processing. Such a locking mechanism may include mating features on the slide housing 120 and base 110 or may comprise a ring that may be placed around the periphery of processing assembly to prevent the apparatus from opening. The processing assembly is depicted in a closed and locked position in FIG. 8.

The base 110 includes a bed 116 for receiving the fluidic device 150. The bed 116 is preferably resilient and may include alignment structures (including, but not limited to, support rails or posts) to secure fluidic devices with and without a carrier. The alignment structures (not depicted) operate to align one or more sealing structures on the staking slide (described below) with at least a portion of a main conduit of the inserted fluidic device 150. The fluidic device 150 is placed in the bed 116 with the deformable surface facing the slide housing 120 and the one or more sealing structures 124. The base may further include ergonomic features 111 to facilitate handling of the integrated processing assembly. In some embodiments, a portion of the base proximate the fluidic device includes an optically transparent material. Suitable materials include, without limitation, polyesters and polycarbonates. Preferably, the portion of the base is above the process chambers, allowing the processing assembly to be placed in an optical reader. In other embodiments, the base comprises at least one aperture (i.e.., through-hole) corresponding to the location of a process chamber when the fluidic device is received in the base. Sections of optically transparent material shaped to cover at an exposed portion of the aperture may also be provided.

The slide housing 120 includes a contact surface 140 and a handling surface 142. In certain embodiments, the contact surface 140 is at least substantially planar. The contact surface 140 may be proximate to or in intimate contact with at least portions of the deformable surface of the fluidic device 150 when the processing assembly is in a closed position. The contact surface 140 features at least one longitudinal staking slot 126. In certain implementations, the staking slot 126 extends along at least substantially the entire length of the contact surface 140. In other implementations, the staking slot 126 has the same length dimensions as a conduit of the fluidic device 150 to be processed.

One or more connectors 160, 162 may be coupled to the slide housing 120 or base 110. The one or more connectors provide electrical connections between the processing assembly and external components in a sample processing system (e.g., the power supply and controller, as discussed below). Furthermore, although the depicted connectors 160 and 162 make only electrical connections for power and/or data transmission between processing assembly and the remainder of the system, it will be understood that the connectors could also make many other connections such as, e.g., optical connections, fluid connections, etc.

In some embodiments, the contact surface 140 includes a thermally conductive material. In other embodiments, the contact surface 140 is coupled to one or more thermally conductive thin plates. The one or more thermally conductive thin plates may be adhered to the underside of the control surface or disposed on the surface proximate the longitudinal staking slot 126. Alternatively, a single thermally conductive thin plate may include at least one longitudinal slot having substantially the same dimensions as the staking slot 126 and may be disposed proximate the contact surface so that the longitudinal slots align.

Suitable materials for the thermally conductive material or plate include, for example, ceramics or metals such as aluminum nitride, aluminum oxide, beryllium oxide, and silicon nitride. Other materials which may be utilized include, e.g., gallium arsenide, silicon, silicon nitride, silicon dioxide, quartz, glass, diamond, polyacrylics, polyamides, polycarbonates, polyesters, polyimides, vinyl polymers, and halogenated vinylpolymers, such as polytetrafluoroethylenes. Other possible materials include thermocouple materials such as chrome/aluminum, superalloys, zircaloy, aluminum, steel, gold, silver, copper, tungsten, molybdenum, tantalum, brass, sapphire, or any of the numerous ceramics, metals, and synthetic polymeric materials available in the art.

The slide housing 120 further includes a staking slide 122 adapted to traverse movement across or within the slide housing 120 from a first position 134 in staking slot 126 to a final staking position. The staking slide 122 may be elongated and may terminate beyond the slide housing 120 in handling fixture 128. The handling fixture 128 extends past second end 114 and may be gripped by human hand or other means (e.g., machine or robot handling) to effect movement of the staking slide 122 in a direction 132 towards the second end 114. The staking slide 122 includes one or more sealing structures 124 (e.g., styli, blades, etc.). Movement of the staking slide 122 when the assembly is closed draws the sealing structures 124 across the deformable surface of the fluidic device. In certain embodiments, the contact surface 140 includes an individual staking slot for each conduit of a fluidic device 150 received in the bed 116.

In the depicted embodiment, the slide housing 120 may include a channel or recess. In some embodiments, the recess comprises substantially the same dimensions as the staking slide 122. In certain preferred embodiments, the recess is larger than the staking slide 122. Guide rail(s) or other alignment structure may be provided within this channel, allowing the staking slide to traverse movement thereon. In such an embodiment, at least a portion of the staking slide is enclosed in the slide housing (e.g., underneath the contact surface 140) and may optionally have slots or other mating features that allow for travel along the guide rails within the slide housing 120. The sealing structure(s) 124 align with and protrude from staking slots 126. The staking slide 122 may thus be moved within this channel, thereby drawing the sealing structure(s) 124 along the length of the staking slot 126.

Alternatively, the staking slide 122 traverses the slide housing 120 along guide rails on a surface of the slide housing 120. In another alternative, the staking slide 122 travels along guide rails on base 110.

The slide housing may further include at least one heating element coupled to the contact surface 140 of the slide housing proximate each staking slot. In some embodiments, the heating element includes a heating device and a thermally conductive plate/material. Suitable heating devices include conductive heaters, convection heaters, or radiation heaters.

In some embodiments, the heating/cooling devices are disposed in the recess or channel of the slide housing 120. Certain heating devices, e.g. thermoelectric films, may be disposed on the contact surface 140. The heating/cooling devices are preferably positioned so that the movement of the staking slide 122 through the channel/recess is not impeded.

Suitable examples of conductive heaters include resistive or inductive heaters, e.g., electric heaters or thermoelectric devices. Suitable convection heating devices include forced air heaters or fluid heat-exchangers (e.g., a heat-conducting block having flow channels so that the block may be heated or cooled by fluid (e.g., water, air) flowing through the channels). In embodiments wherein the processing assembly includes a convection heating device such as forced air or fluid heat exchangers, the source and control of fluid is preferably external to the assembly. Suitable radiation heaters include infrared or microwave heaters. Additional suitable heating devices include an integrated circuit chip as described in WO/2008117209 (Fish et al.).

The processing assembly 100 may further include a cooling device. For example, various convection cooling devices may be employed such as a fan, Peltier device, refrigeration device, or jet nozzle for flowing cooling fluids. Alternatively, various conductive cooling devices may be used, such as a heat sink, e.g. a cooled metal block.

In certain embodiments, the integrated processing assembly 100 includes at least one temperature sensor positioned to measure a temperature of the heating or cooling device. For example, in embodiments in which the heating element comprises a thermally conductive plate and a heating device coupled to the body, the temperature sensor measures the temperature of the heat-conducting body. Alternatively, the sensor may be positioned to measure the temperature of the deformable surface of the fluidic device, a processing chamber, or the temperature of a substance (e.g., fluid) proximate the vessel. In yet another alternative, the temperature is monitored by a sensor capable of detecting colormetric change of the reaction in the process chamber.

The heating/cooling element may be coupled to a power supply. In some embodiments, the power supply is provided onboard the assembly 100. In one implementation, the power supply is provided in the slide housing 120 recess. In another implementation, the power supply is provided in the base 110. Preferably, the power supply is external to the processing assembly and coupled thereto via one of the connectors 160/162.

The assembly 100 may be further coupled to a controller, such as a microprocessor, personal computer, or network computer, for controlling the operation of the heating device by e.g., using temperature feedback from the temperature sensor.

An alternative processing assembly relies on compressive force, not longitudinal movement to occlude the conduits of a fluidic device. In such an embodiment, at least the portion of the slide housing encompassing the staking slide comprises a compressible polymeric material. The staking slide is slidably coupled to the base via posts or other alignment structures that extend at an angle substantially normal to the base. In such an embodiment, the staking slide includes one or more sealing structures, each extending the longitudinal length of the staking slide. In lieu of (or in addition to) traversing movement along a channel, the staking slide is forced downward by compressing at least a portion of the slide housing, with the longitudinal sealing structures occluding the conduits of the retained fluidic device. Alternatively, the slide housing is slidably coupled to the base via posts or other alignment structures that mate when the device processing assembly is closed.

Compressible processing assemblies of the present invention may further include a temporary or breakable stop member disposed between the base and the slide housing proximate the first end (e.g., the non-operatively connected end), preventing compression of the assembly until the occlusion of the fluidic device conduits is desired.

The processing assemblies may be designed with the same overall dimensions as a 50 ml centrifuge tube when in the processing assembly is in the closed position. The loading structures 152 of the fluidic device 150 may optionally protrude beyond one of the base or slide housing. This exposure may allow for sample material to be loaded into the loading structure while the fluidic device is disposed inside a closed processing assembly.

In one exemplary method of sample processing using processing assembly 100, a fluidic device is inserted into base 110 with a fluid sample loaded into a loading structure 152. It is also contemplated that the fluid sample is loaded into a loading structure 152 or otherwise inserted into a process array of the fluidic device after the fluid device has been inserted into base 110. Processing assembly 100 is then brought to a closed position, optionally with the locking mechanism actuated (and, if necessary, stop member engaged). The processing assembly 100 and fluidic device 150 are placed in a centrifuge and rotated, causing the fluid sample to migrate through the distribution channel to the plurality of process chambers. Upon removal from the centrifuge, the staking slide 122 is drawn across the deformable surface of the fluidic device by moving fixture 128 in a direction away from the first end 134 of staking slot 126 or forced against the deformable surface of the fluidic device by applied force to some component of the processing assembly. The fluidic device may then be subject to further analysis and processing (e.g., thermal cycling) as described above.

### EMBODIMENTS

Exemplary integrated processing assemblies and methods of processing sample materials include the following embodiments:
1. A system for processing samples, the system comprising:
   a fluidic device comprising a deformable seal located along at least a portion of one or more process arrays; and
   a sealing apparatus for closing the deformable seals in the fluidic device comprising:
      an elongated housing having an open state and a closed state and including;
         a base adapted to retain a fluidic device; and
         a slide housing operatively connected to the base at a first end and comprising a staking slide.
2. The system of embodiment 1, further comprising one or more sealing structures attached to the staking slide, the sealing structures facing the base, wherein each sealing structure of the one or more sealing structures is adapted to deform at least a portion of the deformable seal.
3. The system of embodiment 2, wherein the staking slide is mounted for traversing movement across the slide housing, and wherein the sealing structures are adapted to deform at least a portion of the deformable seal as the staking slide traverses the slide housing.
4. The system of any of the previous embodiments, wherein the sealing structures are selected from a group consisting of blades, styli, pins, and wires.
5. The system of any of the previous embodiments, wherein the staking slide is enclosed within the slide housing.
6. The system of any of the previous embodiments, wherein a heating element is coupled to the slide housing.
7. The system of embodiment 6, wherein the heating element comprises a thermally conductive material thermally coupled to the second side of the fluidic device when the assembly is in the closed state.
8. An integrated processing assembly for closing deformable seals in a fluidic device comprising:
   a base adapted to retain a fluidic device having a deformable seal;
   a slide housing operatively connected to the base and comprising a staking slide wherein the base and the slide housing define an elongated body having an open state and a closed state; and
   one or more sealing structures attached to the staking slide, the sealing structures facing the base, wherein each sealing structure of the one or more sealing structures is adapted to deform at least a portion of the deformable seal.
9. The integrated processing assembly of embodiment 8, wherein the staking slide is enclosed within the slide housing.
10. The integrated processing assembly of any of the previous embodiments, wherein the staking slide is mounted for traversing movement across a surface of the slide housing.
11. The integrated processing assembly of embodiment 10, wherein the one or more sealing structures is adapted to deform at least a portion of a deformable seal as the staking slide traverse the slide housing.
12. The integrated processing assembly of any of the previous embodiments, wherein the slide housing is hingedly connected to the base.
13. The integrated processing assembly of any of the previous embodiments, wherein a heating element is operatively coupled to the slide housing.
14. The integrated processing assembly of embodiment 13, wherein the heating element comprises a thermally conductive material thermally coupled to the second side of the fluidic device when the assembly is in a closed state.
15. The integrated processing assembly of embodiment 13, wherein the heating element is operatively coupled to a control processor, said control processor external to the integrated processing assembly.
16. The integrated processing assembly of embodiment 13, wherein at least a portion of the heating element is external to the processing assembly.
17. The integrated processing assembly of any of the preceding embodiments, wherein at least one of the bridge or the base comprises an optically transparent material.
18. An integrated processing assembly for closing deformable seals in a fluidic device comprising:
   a base having a cavity to retain a fluidic device including a deformable seal and comprising a first surface;
   a slide housing operatively connected to the base and comprising a second surface,
   a staking slide movably mounted on the second surface to traverse at least a portion of the slide housing; and
   one or more sealing structures attached to the staking slide, the sealing structures facing the base, wherein each sealing structure of the one or more sealing structures is adapted to deform at least a portion of the deformable seal.
19. The integrated processing assembly of embodiment 18, wherein the staking slide is adapted to move across a guide extending along at least a portion of the second surface.
20. A system for processing samples comprising:
   a fluidic device comprising a first and second major surface, wherein the fluidic device includes at least one deformable seal;
   an integrated processing assembly comprising
      a frame adapted to retain the fluidic device, wherein the frame comprises a rail extending across at least a portion of a surface of the frame;
      a staking slide mounted to traverse along the rail; and
      one or more sealing structures operatively connected to the staking slide, wherein the sealing structures are configured to deform at least a portion of the at least one deformable seal and remain in contact with the second major surface as the staking slide traverses the rail.
21. A method of closing deformable seals in a fluidic device, the method comprising:
   providing a fluidic device comprising a body that comprises a first side attached to a second side, and one or more process arrays formed between the first and second sides, a deformable seal located along a portion of the process array;
   locating the fluidic device in an integrated processing assembly, comprising a base adapted to retain the fluidic device; a slide housing operatively attached to the base, a staking slide mounted for movement across the slide housing; and one or more sealing structures attached to the staking slide, the one or more sealing structures facing the fluidic device in the base; and
   closing at least a portion of the deformable seals in the fluidic device located on the base by traversing the slide housing with the staking slide while the fluidic device is located between the base and the bridge, wherein the one or more sealing structures deform at least a portion of the second side of the body to close the deformable seals.
22. The method of embodiment 21, wherein closing at least a portion of the deformable seals comprises drawing the one or more sealing structures across the fluidic device.
23. The method of any of the preceding embodiments, wherein the staking slide is enclosed within the slide housing.
24. The method of any of the preceding embodiments, and further comprising coupling a heating element to the fluidic device and performing thermal processing on the sample.

The complete disclosures of the patents, patent documents, and publications cited herein are incorporated by reference in their entirety as if each were individually incorporated. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

1. A system for processing samples, the system comprising:
a fluidic device comprising a deformable seal located along at least a portion of a process array; and
a sealing apparatus for closing the deformable seals in the fluidic device comprising;
an elongated housing having an open state and a closed state and including a base adapted to retain a fluidic device; and a slide housing operatively connected to the base at a first end and comprising a staking slide.

2. The system of claim 1, further comprising one or more sealing structures attached to the staking slide, the sealing structures facing the base, wherein each sealing structure of the one or more sealing structures is adapted to deform at least a portion of the deformable seal.

3. The system of claim 2, wherein the staking slide is mounted for traversing movement across the slide housing, and wherein the sealing structures are adapted to deform at least a portion of the deformable seal as the staking slide traverses the slide housing.

4. The system of claim 1, wherein the sealing structures are selected from a group consisting of blades, styli, pins, and wires.

5. The system of claim 1, wherein the staking slide is enclosed within the slide housing.

6. The system of claim 1, wherein a heating element is coupled to the slide housing.

7. The system of claim 6, wherein the heating element comprises a thermally conductive material thermally coupled to the second side of the fluidic device.

8. An integrated processing assembly for closing deformable seals in a fluidic device comprising:
a base adapted to retain a fluidic device having a deformable seal;
a slide housing operatively connected to the base and comprising a staking slide wherein the base and the slide housing define an elongated body having an open state and a closed state; and
one or more sealing structures attached to the staking slide, the sealing structures facing the base, wherein each sealing structure of the one or more sealing structures is adapted to deform at least a portion of the deformable seal.

9. The integrated processing assembly of claim 8, wherein the staking slide is enclosed within the slide housing.

10. The integrated processing assembly of claim 8, wherein the staking slide is mounted for traversing movement across a surface of the slide housing.

11. The integrated processing assembly of claim 10, wherein the one or more sealing structures is adapted to deform at least a portion of a deformable seal as the staking slide traverse the slide housing.

12. The integrated processing assembly of claim 8, wherein the slide housing is hingedly connected to the base.

13. The integrated processing assembly of claim 8, wherein a heating element is operatively coupled to the slide housing.

14. The integrated processing assembly of claim 13, wherein the heating element comprises a thermally conductive material thermally coupled to the second side of the fluidic device.

15. The integrated processing assembly of claim 13, wherein the heating element is operatively coupled to a control processor, said control processor external to the integrated processing assembly.

16. The integrated processing assembly of claim 13, wherein at least a portion of the heating element is external to the processing assembly.

17. The integrated processing assembly of claim 8, wherein at least one of the bridge or the base comprises an optically transparent material.

18. An integrated processing assembly for closing deformable seals in a fluidic device comprising:
a base having a cavity to retain a fluidic device including a deformable seal and comprising a first surface;
a slide housing operatively connected to the base and comprising a second surface,
a staking slide movably mounted on the second surface to traverse at least a portion of the slide housing; and
one or more sealing structures attached to the staking slide, the sealing structures facing the base, wherein each sealing structure of the one or more sealing structures is adapted to deform at least a portion of the deformable seal.

19. The integrated processing assembly of claim 18, wherein the staking slide is adapted to move across a guide extending along at least a portion of the second surface.

20. A system for processing samples comprising:
a fluidic device comprising a first and second major surface, wherein the fluidic device includes at least one deformable seal;
an integrated processing assembly comprising a frame adapted to retain the fluidic device, wherein the frame comprises a rail extending across at least a portion of a surface of the frame; a staking slide mounted to traverse along the rail; and one or more sealing structures operatively connected to the staking slide, wherein the sealing structures are configured to deform at least a portion of the at least one deformable seal and remain in contact with the second major surface as the staking slide traverses the rail.

21. A method of closing deformable seals in a fluidic device, the method comprising:
providing a fluidic device comprising a body that comprises a first side attached to a second side, and one or more process arrays formed between the first and second sides, and a deformable seal located along a portion of the process array;
locating the fluidic device in an integrated processing assembly, comprising a base adapted to retain the fluidic device; a slide housing operatively attached to the base, a staking slide mounted for movement across the slide housing; and one or more sealing structures attached to the staking slide, the one or more sealing structures facing the fluidic device in the base; and
closing at least a portion of the deformable seals in the fluidic device located on the base by traversing the slide housing with the staking slide while the fluidic device is located between the base and the bridge, wherein the one or more sealing structures deform at least a portion of the second side of the body to close the deformable seals.

22. The method of claim 21, wherein closing at least a portion of the deformable seals comprises drawing the one or more sealing structures across the fluidic device.

23. The method of claim 21, wherein the staking slide is enclosed within the slide housing.

24. The method of claim 21, and further comprising coupling a heating element to the fluidic device and performing thermal processing on the sample.
